(19) United States
(12) Patent Application Publication
(10) Pub. No.: US 2010/0150430 A1
(43) Pub. Date: Jun. 17, 2010

(54) VISUAL INSPECTION APPARATUS AND VISUAL INSPECTION METHOD FOR SEMICONDUCTOR LASER CHIP OR SEMICONDUCTOR LASER BAR

(75) Inventor: Nobuyuki MITSUI, Osaka-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/634,237

(22) Filed: Dec. 9, 2009

(30) Foreign Application Priority Data
Dec. 12, 2008 (JP) 2008-317523

(51) Int. Cl. G06K 9/00

(52) U.S. Cl. 382/149

(57) ABSTRACT

With a semiconductor laser chip that is an inspection object being pushed up from the back surface of an adhesive sheet by a push-up member and the semiconductor laser chip being positioned above the other semiconductor laser chips, the images of both light-emitting end surfaces of the semiconductor laser chip are taken with CCD cameras. Then, on the basis of information of an image taken by the CCD cameras, an visual inspection unit built in a computer determines the goodness or badness of the appearance of the semiconductor laser chip.

### BACKGROUND OF THE INVENTION

1. Field of the Invention

The present invention relates to an visual inspection apparatus and an visual inspection method for a semiconductor laser chip or a semiconductor laser bar, the apparatus and method being used for determining the goodness or badness of the appearance of a light-emitting end surface of the semiconductor laser chip or the semiconductor laser bar by taking the image of it with a camera.

2. Description of the Related Art

When semiconductor laser chips are manufactured, for example, electrodes and a circuit pattern are formed on a wafer, so that a plurality of semiconductor laser chip groups are formed on one wafer. By dividing the wafer into bars so that both front and back end surfaces, which become light-emitting end surfaces, of the semiconductor laser chips appear, semiconductor laser bars in which the plurality of laser chips are consecutively provided are obtained. The dividing of the wafer is performed by a breaking operation after scribing the wafer. By dividing the semiconductor laser bars into chips, the semiconductor laser chips are obtained. More specifically, such semiconductor laser chips are obtained by the following process. First, semiconductor laser bars are affixed to a adhesive sheet. Then, similarly to the above, the semiconductor laser bars are subjected to scribing/breaking. Then, the adhesive sheet to which the semiconductor laser bars are adhered is expanded. Lastly, the adhesive sheet is irradiated with UV light to reduce adhesive strength, after which semiconductor chips are picked up from the adhesive sheet.

An apparatus that inspects the appearance of a light-emitting end surface of a semiconductor laser chip is disclosed in, for example, Japanese Unexamined Patent Application Publication No. 7-50327. The visual inspection apparatus discussed in Japanese Unexamined Patent Application Publication No. 7-50327 handles laser diode chips one at a time and transfers them to a table. Then, by displaying on a monitor television an image from a CCD camera disposed in the vicinity of the table, an operator visually inspects the image displayed on the monitor television.

However, in the visual inspection apparatus discussed in Japanese Unexamined Patent Application Publication No. 7-50327, since the appearance is inspected by transferring the semiconductor laser chips one at a time to the table, a transfer operation is required. In addition, the semiconductor laser chips may be scratched when they are handled. Further, since it takes time to perform the transfer operation, it takes time to inspect the appearance.

### SUMMARY OF THE INVENTION

Accordingly, in view of the aforementioned circumstances, one object of the present invention is to provide an visual inspection apparatus and an visual inspection method for a semiconductor laser chip or semiconductor laser bar, which do not require a transfer operation and which can inspect a light-emitting end surface.

According to a first aspect of the present invention, there is provided an visual inspection apparatus for a semiconductor laser chip or a semiconductor laser bar including a stage, a push-up member, a camera, and visual inspecting means. Here, an adhesive sheet is placed at the stage, a plurality of the semiconductor laser chips or a plurality of the semiconductor laser bars being adhered to a surface of the adhesive sheet. The push-up member pushes up a semiconductor laser chip or a semiconductor laser bar that is an inspection object from the back surface of the adhesive sheet to position the semiconductor laser chip or the semiconductor laser bar that is an inspection object above the other semiconductor laser chips or the other semiconductor laser bars. The camera takes an image of a light-emitting end surface of the semiconductor laser chip or the semiconductor laser bar pushed up by the push-up member. The visual inspecting means determines the goodness or badness of the appearance of the semiconductor laser chip or the semiconductor laser bar on the basis of information of the image of the light-emitting end surface of the semiconductor laser chip or the semiconductor laser bar taken by the camera.

According to a second aspect of the present invention, there is provided a method of visual inspection for a semiconductor laser chip or a semiconductor laser bar including the following steps. They are:

(1) placing an adhesive sheet at a stage, a plurality of the semiconductor laser chips or a plurality of the semiconductor laser bars being adhered to a surface of the adhesive sheet;

(2) pushing up a semiconductor laser chip or a semiconductor laser bar that is an inspection object among the plurality of the semiconductor laser chip or the plurality of the semiconductor laser bar by a push-up member from the back surface of the adhesive sheet to position the semiconductor laser chip or the semiconductor laser bar that is an inspection object above the other semiconductor laser chips or the other semiconductor laser bars;

(3) taking an image of a light-emitting end surface of the semiconductor laser chip or the semiconductor laser bar pushed up by the push-up member with a camera; and

(4) determining the goodness or badness of the appearance of the semiconductor laser chip or the semiconductor laser bar on the basis of information of the image of the light-emitting end surface of the semiconductor laser chip or the semiconductor laser bar taken by the camera in the imaging step.

According to this structure, the semiconductor laser chip or the semiconductor laser bar that is an inspection object can be positioned above the other semiconductor laser chips or the semiconductor laser bars. Therefore, it is possible to inspect the light-emitting end surface of the semiconductor laser chip or the semiconductor laser bar that is an inspection object by taking the image of it with a camera without being interfered by the other semiconductor laser chips or semiconductor laser bars. In addition, with the semiconductor laser chip or the semiconductor laser bar being affixed to the adhesive sheet, the light-emitting end surface of the semiconductor laser chip or the semiconductor laser bar can be inspected. Therefore, the semiconductor laser chip or the semiconductor laser bar does not need to be transferred. Consequently, it is possible to prevent scratching thereof caused by handling of it, and to reduce the inspection time.

An example of a camera used in the visual inspection apparatus according to the present invention is a camera containing a charge coupled device (CCD). Information of an image taken by the camera is sent to visual inspecting means and is subjected to, for example, image processing, to determine the goodness or badness of the appearance of a semiconductor laser chip or a semiconductor laser bar. In the image processing, for example, a binarization operation or pattern matching is performed. Then, an edge of a light-emitting end surface of the semiconductor laser chip or the semiconductor laser bar is detected to detect any scratches or defects of the light-emitting end surface, any foreign matter adhered to the end surface, or an adhesion state of a coating film. For the image processing, a publicly known technology may be used.

It is desirable that the visual inspection apparatus according to the present invention further include upward-downward position adjusting means for adjusting an upward or a downward position of the semiconductor laser chip or the semiconductor laser bar. It is possible to take an image of a semiconductor laser chip or a semiconductor laser bar with the camera by moving the stage and the push-up member relative to each other in an upward or downward direction (Z direction) in accordance with an imaging range of the camera.

In an visual inspection method according to the present invention, it is desirable that the image of the entire light-emitting end surface is taken in a plurality of steps while an upward position or a downward position of the semiconductor laser chip or the semiconductor laser bar whose image is taken by the camera is adjusted. In the imaging step, it is possible to take the image of a semiconductor laser chip or a semiconductor laser bar with the camera by moving the stage and the push-up member relative to each other in the upward or downward direction in accordance with a imaging range of the camera.

In recent years, there is a very high demand with regard to the quality of the appearance of a semiconductor laser chip. In order to achieve high-precision inspection, it is desirable to take the image of a light-emitting end surface of a semiconductor laser chip or a semiconductor laser bar (which is a semimanufactured product of the semiconductor laser chip) with a high-magnification camera. However, if it is an image taken with a high magnification, a imaging range is correspondingly narrowed. This may not allow inspection of the entire light-emitting end surface in one imaging operation. For example, it is possible for only the upper portion in a thickness direction of the semiconductor laser chip or a semiconductor laser bar to enter the imaging range, and the lower portion to be outside the imaging range.

According to the above-described structure, even if the camera is a fixed focus camera, it is possible to take an image of an entire light-emitting end surface of a semiconductor laser chip or a semiconductor laser bar. For example, first, a semiconductor laser chip or a semiconductor laser bar that is an inspection object is positioned to an upper location by the push-up member, and the image of the upper portion of the light-emitting end surface of the semiconductor laser chip or the semiconductor laser bar is taken. Next, it is possible to take the image of the lower portion of the light-emitting end surface by moving the stage and the push-up member upward. Here, an example in which the image of the entire light-emitting end surface is taken in two steps, that is, the step of taking the image of the upper portion and the step of taking the image of the lower portion is given. However, the image of the entire light-emitting end surface may be taken intermittently or continuously in a plurality of steps, such as three or more steps. Instead of the upward-downward position adjusting means, a camera raising-lowering mechanism may be provided. After taking the image of the upper portion of the light-emitting end surface of the semiconductor laser chip or the semiconductor laser bar, it is possible to take the image of the lower portion of the light-emitting end surface by moving the camera downward while the position of the stage and the position of the push-up member are maintained. Also, after taking the image of the upper portion of the light-emitting end surface of the semiconductor laser chip or the semiconductor laser bar, the image of the lower portion may be taken by changing the orientation of the camera, that is, by correcting the tilt of the camera. However, if the orientation of the camera is changed, defocusing may occur in the fixed focus camera. In contrast, in the above-described structure, the image of the entire end surface is taken in a plurality of steps while the orientation of the camera is maintained. Therefore, defocusing does not occur, thereby making it possible to inspect the light-emitting end surface of the semiconductor laser chip or the semiconductor laser bar with high precision.

In contrast, if a camera whose focus is adjustable is used, a camera oscillating mechanism may be provided. After taking the image of the upper portion of a light-emitting end surface of a semiconductor laser chip or the semiconductor laser bar, it is possible to take the image of the lower portion of the light-emitting end surface by changing the orientation of the camera and tilting the camera downward. The focusing may be manually performed while confirming an image of the camera, or automatically performed by an automatic focusing mechanism.

It is desirable that the visual inspection apparatus for a semiconductor laser chip or a semiconductor laser bar further include two of the cameras, wherein both of the images of the light-emitting end surfaces of the semiconductor laser chip or the semiconductor laser bar that is an inspection object are taken by the different cameras, respectively.

If the visual inspection apparatus includes only one camera, a camera swinging mechanism may be provided. For example, the camera swinging mechanism is provided so that the camera can swing around a semiconductor laser chip or a semiconductor laser bar that is an inspection object. This makes it possible to take the images of both light-emitting end surfaces of the semiconductor laser chip or the semiconductor laser bar that is an inspection object. Alternatively, the orientation of the semiconductor laser chip or the semiconductor laser bar that is an inspection object may be changed by rotating the stage. However, this results in, for example, the necessity of providing a camera swinging mechanism or a swinging space. In contrast, in the above-described structure, by using two cameras, it is possible to take the images of both light-emitting end surfaces of the semiconductor laser chip or the semiconductor laser bar that is an inspection object at one time. This makes it possible to also reduce the inspection time. Alternatively, a pair of fiber scopes are provided, an end of each fiber scope is oriented toward its corresponding light-emitting end surface of the semiconductor laser chip or the semiconductor laser bar, and the other end of each fiber scope is connected to the camera. This makes it possible to take the image of both light-emitting end surfaces of the semiconductor laser chip or the semiconductor laser bar with one camera.

It is desirable that the size of the shape of the upper surface of the push-up member be set in correspondence with the semiconductor laser chips or the semiconductor laser bars.

According to this structure, if a semiconductor laser chip is selected as an inspection object, it is possible to inspect a light-emitting end surface of the semiconductor laser chip by forming the shape of the push-up member in correspondence with the size of the semiconductor laser chip. If a semiconductor laser bar is selected, it is possible to inspect a light-emitting end surface of the semiconductor laser bar by forming the shape of the push-up member in correspondence with the size of the semiconductor laser bar. When inspecting the semiconductor laser bar, only a portion in a longitudinal direction of the semiconductor laser bar may enter the imaging range. In this case, it is possible to take the image of the entire light-emitting end surface in a plurality of steps by moving the camera or the stage in parallel along the longitudinal direction of the semiconductor laser bar.

It is desirable that the upper surface of the push-up member have a suction hole communicating with a vacuum pump.

According to this structure, a suction hole is formed in the upper surface of the push-up member that contacts the adhesive sheet. By this, when a semiconductor laser chip or a semiconductor laser bar that is an inspection object is pushed upward from the bottom surface of the adhesive sheet by the push-up member, it is possible for the adhesive sheet to be attracted and adhered to the upper surface of the push-up member. Therefore, the position of the semiconductor laser chip or the semiconductor laser bar pushed up by the push-up member is stabilized, thereby increasing inspection precision.

It is desirable that the visual inspection apparatus according to the present invention further include a first current applying probe, a second current applying probe, a power supply, a light detector, and optical characteristic inspecting means. The first current applying probe is disposed above the stage and contacts a upper-surface electrode of the semiconductor laser chip that is an inspection object. The second current applying probe is mounted to the push-up member, and moves through the adhesive sheet to contact a back-surface electrode of the semiconductor laser chip. The power supply causes outgoing light to be emitted from the light-emitting end surface of the semiconductor laser chip by applying current to the upper-surface electrode and the back-surface electrode from the first and second current applying probes. The light detector detects the outgoing light of the semiconductor laser chip. Optical characteristic inspecting means determines the goodness or badness of optical characteristics of the semiconductor laser chip on the basis of detection results of the light detector.

According to this structure, it is possible not only to inspect the appearance of a light-emitting end surface of a semiconductor laser chip or a semiconductor laser bar, but also to inspect the optical characteristics of the semiconductor laser chip using one device. The optical characteristics include, for example, electric current—light output characteristics, oscillation spectrum characteristics, and a far field pattern.

The first and second current-applying probes are connected to the power supply. The first current-applying probe is formed, for example, so as to be capable of moving upward and downward. The first current-applying probe may be designed so that, when current is applied to a semiconductor laser chip, the first current-applying probe moves downward and comes into contact with a upper-surface electrode. The second current-applying probe is built in, for example, the push-up member, and is formed so as to be capable of moving upward and downward. The second current-applying probe may be designed so that, when current is applied to the semiconductor laser chip, the second current-applying probe moves upward, moves through the adhesive sheet, and comes into contact with a back-surface electrode.

It is desirable that the visual inspection apparatus according to the present invention further include position information detecting means and horizontal position adjusting means.

According to this structure, first, the position information detecting means detects position information of a semiconductor laser chip or a semiconductor laser bar that is an inspection object among the plurality of semiconductor laser chips or semiconductor laser bars. Next, by moving the stage by the horizontal position adjusting means on the basis of the position information, the semiconductor laser chip or the semiconductor laser bar that is an inspection object is successively changed. It is possible to automatically and continuously inspect successively the plurality of semiconductor laser chips or the semiconductor laser bars, thereby increasing operation efficiency. Here, the term “horizontal” does not only indicate left and right directions (X directions) or only front and back directions (Y directions). The term may also indicate both the X and Y directions, and rotational directions (θ directions) in an XY plane.

The position information detecting means used in the visual inspection apparatus according to the present invention includes, for example, an image processing device and a CCD camera disposed above the stage. The position information detecting means is designed so as to perform image processing on information of an image taken by the CCD camera, and to obtain information of the positions of all of the semiconductor laser chips or semiconductor laser bars. The image processing mentioned here is one in which, for example, a binarization operation or pattern matching is performed, and border lines of the semiconductor laser chips or semiconductor laser bars are detected to detect information of the positions thereof. For these, publicly known technologies can be used.

The visual inspection apparatus and visual inspection method for a semiconductor laser chip or semiconductor laser bar make it possible to take an image with the camera and to inspect a light-emitting end surface of a semiconductor laser chip or a semiconductor laser bar that is an inspection object among the plurality semiconductor laser chips or semiconductor laser bars while they are adhered to the adhesive sheet. Consequently, the semiconductor laser chip or the semiconductor laser bar does not need to be transferred. Thus, it is possible to prevent scratching thereof caused by handling of it, and to reduce the inspection time.

### BRIEF DESCRIPTION OF THE DRAWINGS

FIG. 1 is a schematic view of an exemplary structure of an visual inspection apparatus for a semiconductor laser chip or a semiconductor laser bar according to a first embodiment of the present invention;

FIG. 2A is a schematic view of a step of providing semiconductor laser chips, and shows a state viewed from above a adhesive sheet to which semiconductor laser bars are adhered;

FIG. 2B is a schematic view of the step of providing the semiconductor laser chips, and shows a state viewed from a side of the adhesive sheet to which the semiconductor bars are adhered;

FIG. 2C is a schematic view of the step of providing the semiconductor laser chips, and shows a state viewed from a side of a stage on which the adhesive sheet is placed;

FIG. 3A is a schematic view showing an operation procedure of the visual inspection apparatus shown in FIG. 1, and shows a state before pushing up a semiconductor laser chip that is an inspection object by a push-up member;

FIG. 3B is a schematic view showing an operation procedure of the visual inspection apparatus shown in FIG. 1, and shows a state after pushing up the semiconductor laser chip that is an inspection object by the push-up member;

FIG. 4A is a schematic view illustrating upward-downward position adjusting means of an visual inspection apparatus according to Application 1, and shows a state in which the image of the upper portions of light-emitting end surfaces of a semiconductor laser chip are taken with cameras;

FIG. 4B is a schematic view illustrating the upward-downward position adjusting means of the visual inspection apparatus according to the Application 1, and shows a state in which the image of the lower portions of the light-emitting end surfaces of the semiconductor laser chip are taken with the cameras; and

FIG. 5 is a schematic view illustrating a push-up member of an visual inspection apparatus according to Application 2.

### DESCRIPTION OF THE PREFERRED EMBODIMENTS

Embodiments of the present invention will hereunder be described with reference to the drawings. In the figures, corresponding members are given the same reference numerals.

### First Embodiment

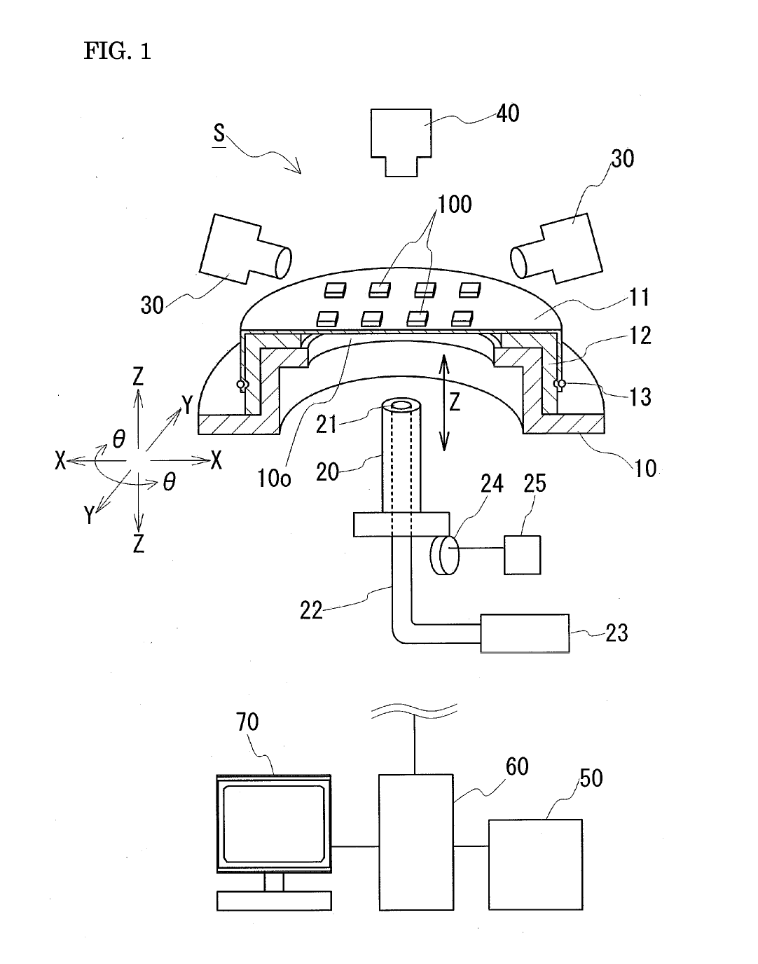

FIG. 1 is a schematic view of an exemplary structure of an visual inspection apparatus for a semiconductor laser chip or a semiconductor laser bar according to a first embodiment of the present invention;

An visual inspection apparatus S for a semiconductor laser chip or a semiconductor laser bar includes a stage 10, a push-up member 20, CCD cameras 30 for taking a image of an end surfaces of a semiconductor laser chip or a semiconductor laser bar, a CCD camera 40 for detecting information of the position of the semiconductor laser chip or the semiconductor laser bar, an image processing device 50, an electronic calculator (computer) 60, and a monitor 70. Each structural member will hereunder be described in detail.

The stage 10 is a member where a adhesive sheet 11 (to whose surface a plurality of semiconductor laser chips or semiconductor laser bars 100 are adhered) is placed, and has an opening 10o. The stage 10 is movable in horizontal directions (X directions and Y directions), vertical directions (Z directions), and rotational directions (θ directions) in an XY plane, and is controlled by the computer 60.

A push-up member 20 is disposed below the stage 10, and moves in the opening 10o of the stage 10 in the upward and downward directions (Z directions). By this, the push-up member 20 pushes up a semiconductor laser chip or a semiconductor laser bar 100 that is an inspection object from the back surface of the adhesive sheet 11, and causes it to be positioned above the other semiconductor laser chips or the semiconductor laser bars 100. In the embodiment, the upward and downward movement of the push-up member 20 is realized by an eccentric cam 24 and a motor 25 that rotationally drives the eccentric cam 24, and is controlled by the computer 60.

The upper surface of the push-up member 20 that contacts the adhesive sheet 11 is formed into a substantially horizontal surface, and has a suction hole 21. The suction hole 21 is connected to a vacuum pump 23 through a communication tube 22. When the semiconductor laser chip or the semiconductor laser bar 100 that is an inspection object is pushed upward from the back surface of the adhesive sheet 11 by the push-up member 20, the suction hole 21 attracts the adhesive sheet 11 and causes it to come into close contact with the upper surface of the push-up member 20, and stabilizes the position of the semiconductor laser chip or the semiconductor laser bar 100. The vacuum pump 23 is controlled by the computer 60.

The CCD cameras 30 obtain image information by taking the image of the light-emitting end surfaces of the semiconductor laser chip or the semiconductor laser bar 100 that is an inspection object that is pushed up by the push-up member 20. In the embodiment two fixed focus cameras 30 are used, and the images of both light-emitting end surfaces of the semiconductor laser chip or the semiconductor laser bar 100 that is an inspection object can be taken at one time. In addition, since the upper surface of the push-up member 20 is formed into a substantially horizontal surface, the semiconductor laser chip or the semiconductor laser bar 100 that is an inspection object is pushed up while being maintained in a horizontal state. Therefore, the images of both light-emitting end surfaces of the semiconductor laser chip or the semiconductor laser bar 100 are easily taken. In the embodiment, in order to prevent the CCD cameras 30 and the stage 10 (adhesive sheet 11) from contacting each other, each CCD camera 30 is maintained in a tilted state of approximately 30 degrees with respect to the horizontal surface.

In order to detect information of the position of the semiconductor laser chip or the semiconductor laser bar 100 that is an inspection object among the plurality of semiconductor laser chips or semiconductor laser bars 100, the CCD camera 40 is disposed above the stage 10, and takes an image of a surface of the adhesive sheet 11 to obtain the image information. The CCD cameras 30 and the CCD camera 40 are controlled by the computer 60, and the information of the image taken by the CCD cameras is sent to the computer 60.

The image processing device 50 is controlled by the computer 60 and performs a predetermined image processing operation on the information of the image sent from the computer 60. More specifically, for the information of the image taken by the CCD cameras 30, the image processing operation for detecting any scratches or defects on optical end surfaces of the semiconductor laser chip or semiconductor laser bar 100 is performed, and the detection information is sent to the computer 60. The image processing operation for detecting any scratches or detects on the optical end surfaces of the semiconductor laser chip or the semiconductor laser bar 100 and the image processing operation for detecting the information of the position of the semiconductor laser chip or the semiconductor laser bar 100 uses a publicly known image processing technology.

The computer 60 performs a controlling operation for generating a command to each of the aforementioned structural members and processes information that is sent, and includes appearance inspecting means and horizontal position adjusting means.

The appearance inspecting means performs the image processing operations using the image processing device 50 on information of the image taken by the CCD cameras 30, and determines the goodness or badness of the appearance of the semiconductor laser chip or the semiconductor laser bar 100 from information of detection of any scratches or defects on the optical end surfaces of the semiconductor laser chip or the semiconductor laser bar 100 subjected to the image processing operations. The goodness or badness of the appearance is determined on the basis of information of the number, the position, the shape of any scratches or defects included in the detection information. On the basis of the information of the position of the semiconductor laser chip or the semiconductor laser bar 100 that is an inspection object obtained from the image processing device 50, the horizontal position adjusting means moves the stage 10 horizontally so that the semiconductor laser chip or the semiconductor laser bar 100 comes directly above the push-up member 20.

The monitor 70 is provided for an operator to confirm execution of an instruction with respect to each of the above-described structural members or an image taken by the CCD cameras 30 and the CCD camera 40.

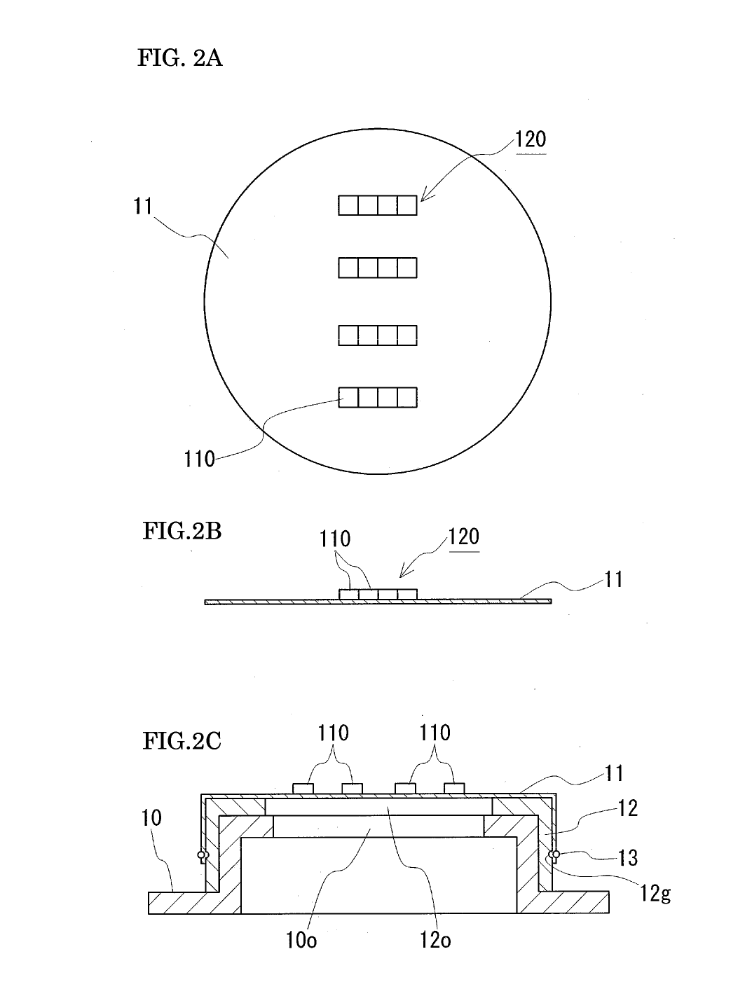

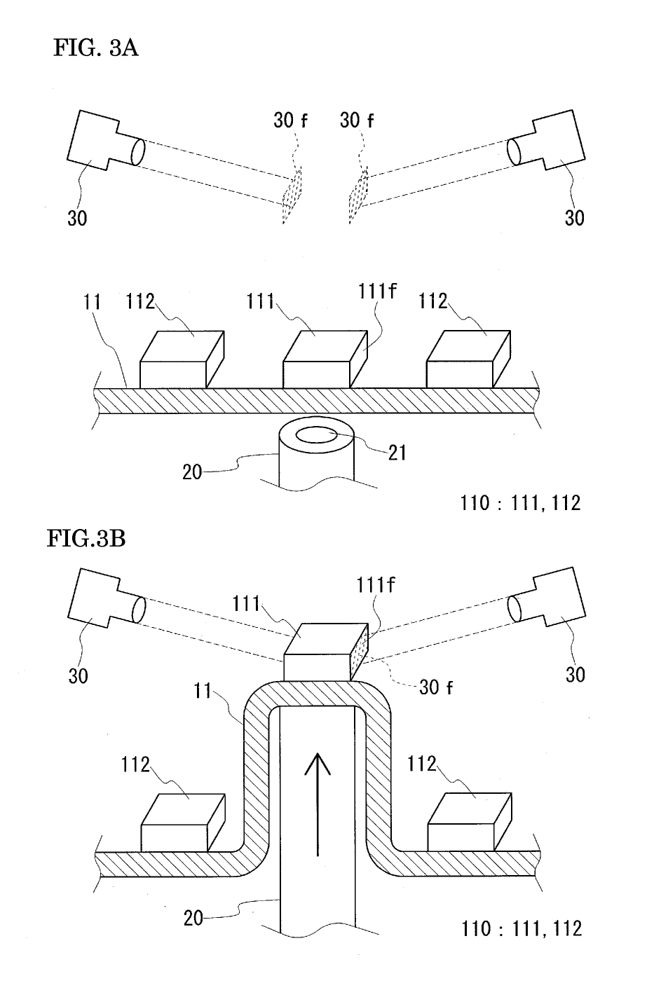

Next, the operating procedure of the visual inspection apparatus S will be described. Here, the case in which a semiconductor laser chip that is an inspection object is selected, and the size of the shape of the upper surface of the push-up member is set in correspondence with the semiconductor laser chip is described. FIG. 2A is a schematic view of a step of providing semiconductor laser chips, and shows a state viewed from above the adhesive sheet to which semiconductor laser bars are adhered. FIG. 2B is a schematic view of the step of providing the semiconductor laser chips, and shows a state viewed from a side of the adhesive sheet to which the semiconductor bars are adhered. FIG. 2C is a schematic view of the step of providing the semiconductor laser chips, and shows a state viewed from a side of a stage 10 on which the adhesive sheet is placed. FIG. 3A is a schematic view showing an operation procedure of the aforementioned visual inspection apparatus, and shows a state before pushing up a semiconductor laser chip 111 that is an inspection object by the push-up member 20. FIG. 3B is a schematic view showing an operation procedure of the aforementioned visual inspection apparatus, and shows a state after pushing up the semiconductor laser chip 111 that is an inspection object by the push-up member 20.

The semiconductor laser chips are provided as follows. Electrodes and a circuit pattern are formed on a wafer, to provide the wafer on which a plurality of semiconductor laser chip groups are formed. This wafer is divided into semiconductor laser bars 120 so that both front and back end surfaces, which are light-emitting end surfaces, of the semiconductor laser chips appear. The semiconductor laser bars 120 have the plurality of semiconductor laser chips consecutively formed, and are adhered to a surface of the adhesive sheet 11. The adhesive sheet 11 is formed of a material having elasticity and whose adhesive strength is reduced when it is irradiated with UV light. Next, the semiconductor laser bars 120 are subjected to scribing/breaking in semiconductor laser chip units, and are thus divided into individual semiconductor laser chips 110 (see FIGS. 2A and 2B). Thereafter, the adhesive sheet 11 is expanded to increase the interval between the individual semiconductor laser chips 110. With this state being maintained, the adhesive sheet 11 is made to cover a supply ring 12 from above the supply ring 12, and is secured to the supply ring 12 with an O ring 13 (see FIG. 2C). The supply ring 12 has an opening 12o. A groove 12g for fitting the O ring 13 thereto is formed in the outer peripheral surface of the supply ring 12.

Then, the supply ring 12 is set on the stage 10. With the adhesive sheet 11 to whose surface the plurality of semiconductor laser chips 110 are adhered being set on the stage 10, the operation of the visual inspection apparatus S is started.

First, the visual inspection apparatus S obtains information of the position of a semiconductor laser chip 111 that is an inspection object from information of an image taken by the CCD cameras for detecting the positional information. On the basis of the positional information, the horizontal position controlling means moves the stage 10 (adhesive sheet 11) horizontally, and positions the semiconductor laser chip 111 that is an inspection object directly above the push-up member 20 (see FIG. 3A). Next, the push-up member 20 is raised to push up the semiconductor laser chip 111 that is an inspection object from the back surface of the adhesive sheet 11. With the semiconductor laser chip 111 that is an inspection object being positioned above the other semiconductor laser chips 112 that are not inspected, the images of both light-emitting end surfaces 111f of the semiconductor laser chip 111 that is an inspection object are taken with the CCD cameras 30 (see FIG. 3B). Here, a imaging range 30f of each CCD camera 30 is previously set at the position of its corresponding light-emitting end surface 111f when the semiconductor laser chip 111 that is an inspection object is pushed up by the push-up member 20. After the imaging operation, the push-up member 20 is moved downward to a reference position where it does not contact the adhesive sheet (see FIG. 3A). Then, the visual inspecting means performs image processing on the information of the image taken by the CCD cameras 30, and determines the goodness or badness of the appearance of the semiconductor laser chip 111 that is an inspection object from information of detection of any scratches or defects on the light-emitting end surfaces 111f obtained by the image processing. The inspected semiconductor laser chip 111 determined as being a defective product by the appearance inspecting means is, for example, marked by an operator, so that the defective product can be distinguished from good products later. Alternatively, a marker mechanism that automatically marks a defective product on the basis of the positional information of the semiconductor laser chip may be provided.

The inspection of the appearance of the semiconductor laser chip 111 that is an inspection object is completed. Subsequently, a semiconductor laser chip that is an inspection object is successively changed. When the inspections of the appearances of all of the semiconductor laser chips 110 being completed, the operation of the visual inspection apparatus S ends.

The visual inspection apparatus S according to the first embodiment described above positions a semiconductor laser chip 111 that is an inspection object among the plurality of semiconductor laser chips adhered to the adhesive sheet 11 above the other semiconductor laser chips 112 that are not inspected. This makes it possible to inspect the light-emitting end surfaces 111f of the semiconductor laser chip 111 that is an inspection object by taking the image of them with the CCD cameras 30 without being interfered by the other semiconductor laser chips 112 that are not inspected. In addition, since, with the semiconductor laser chips 110 being adhered to the adhesive sheet 11, the appearances of the light-emitting end surfaces 111f of the semiconductor laser chips 110 can be inspected, transfer of the semiconductor laser chips 110, which was hitherto required, need not be performed. Further, it is possible to automatically and continuously inspect the appearances of the plurality of semiconductor laser chips by the horizontal position adjusting means obtaining the information of the position of the semiconductor laser chip 111 that is an inspection object and moving the stage 10 horizontally on the basis of the positional information.

Applications of the present invention will hereunder be described.

### Application 1

In Application 1, upward-downward position adjusting means is added to the computer 60 of the above-described visual inspection apparatus S. The other features of the Application 1 are the same as those of the first embodiment. Here, the description will be focused on the upward-downward position adjusting means, so that the other features will not described.

The upward-downward position adjusting means adjusts the upward position or downward position of the semiconductor laser chip or the semiconductor laser bar 100 whose image is taken by the CCD cameras 30 by moving the stage 10 and the push-up member 20 relative to each other to the upward or downward (Z direction) position in accordance with the imaging range of each CCD camera 30.

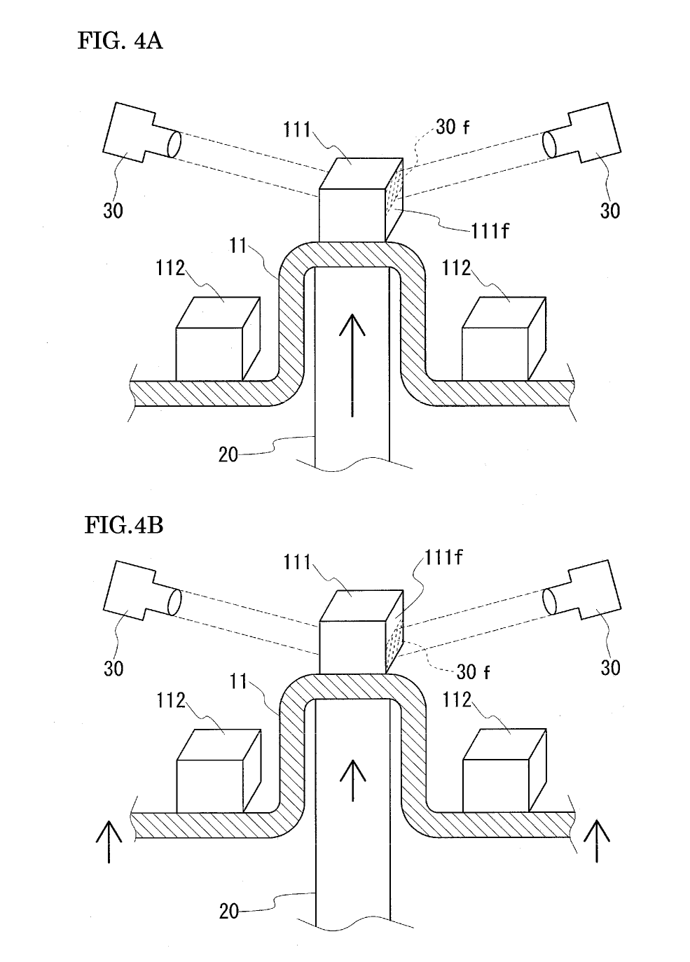

The functions of the upward-downward position adjusting means are described with reference to FIGS. 4A and 4B. If the CCD cameras 30 have high magnifications compared to related cameras, the image of the entire light-emitting end surfaces 111f of the semiconductor laser chip 111 that is an inspection object and taken may no longer enter the imaging ranges 30f. For example, only the upper portion of each light-emitting end surface 111f of the semiconductor laser chip 111 that is an inspection object may enter the imaging range 30f, and the lower portion thereof may be outside the imaging range 30f. In order to take the images of the entire light-emitting end surfaces 111f of the semiconductor laser chip 111 that is an inspection object, the images of the entire light-emitting end surfaces 111f may be taken by changing the orientation (tilting) of each CCD camera 30. However, in this case, defocusing may occur. To overcome such a problem, the upward-downward position adjusting means moves the push-up member 20 upward to position the semiconductor laser chip 111 to an upward location, so that the images of the upper portions of the light-emitting end surfaces 111f of the semiconductor laser chip 111 that is an inspection object are taken by the CCD cameras 30 (see FIG. 4A). Thereafter, in order to take the images of the remaining lower portions of the light-emitting end surfaces 111f with the CCD cameras 30, the stage 10 (adhesive sheet 11) and the push-up member 20 are both moved upward (see FIG. 4B).

In this way, in the visual inspection apparatus according to the Application 1, since, with the orientations of the CCD cameras 30 being unchanged and the focus being fixed, the images of the entire light-emitting end surfaces 111f of the semiconductor laser chip 111 that is an inspection object are taken in a plurality of steps, defocusing does not occur. In addition, since they are taken with the CCD cameras 30 having high magnifications, it is possible to inspect the light-emitting end surfaces 111f of the semiconductor laser chip 111 that is an inspection object with high precision.

When taking the images of the lower portions of the light-emitting end surfaces 111f of the semiconductor laser chip 111 that is an inspection object, the upward-downward position adjusting means moves both the stage 10 and the push-up member 20 upward. It is possible to move only the push-up member 20 further upward to take the images of the lower portions of the light-emitting end surfaces 111f. However, in this case, the stretching of the adhesive sheet 11 may exceed its limit and undergo plastic deformation or break. In contrast, in the aforementioned upward-downward position adjusting means, it is possible to overcome such a problem.

### Application 2

In an visual inspection apparatus of Application 2, the shape of the suction hole 21 of the push-up member 20 is changed.

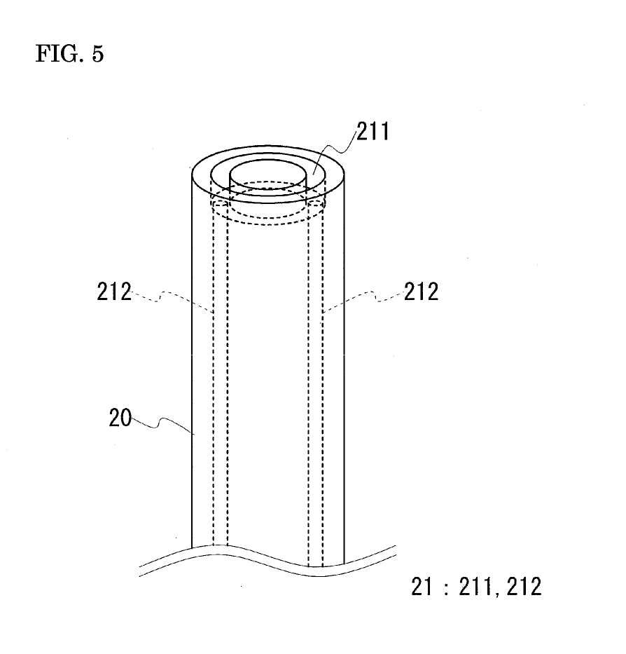

The push-up member 20 is not limited to the structure shown in FIG. 1 in which one suction hole 21 is formed in the center of the upper surface. The push-up member 20 may have a structure in which two or more suction holes are formed in the upper surface. In addition, as shown in FIG. 5, the push-up member 20 may have a structure in which a suction hole 21 is formed by an annular groove 211 formed in the upper surface and two holes 212 formed at the bottom surface of the groove 211.

### Application 3

In Application 3, a structure that inspects the optical characteristics of a semiconductor laser chip is added to the above-described visual inspection apparatus S. The other features are the same as those of the first embodiment. Here, the description will be focused on the structural member that inspects the optical characteristics of a semiconductor laser chip, so that the other features will not be described.

The visual inspection apparatus of the Application 3 includes a first current applying probe, a second current applying probe, a power supply, a light detector, and optical characteristics inspecting means.

The first current applying probe is a member that is disposed above the stage and that contacts a upper-surface electrode of a semiconductor laser chip that is an inspection object. More specifically, the first current applying probe is formed so as to be capable of moving up and down, and is controlled by the computer so that it moves downward and contacts the upper surface electrode when current is applied to the semiconductor laser chip. The second current applying probe is a member that is mounted to the push-up member and that contacts a back-surface electrode of the semiconductor laser chip. More specifically, the second current applying probe is built in the push-up member, is formed so as to be capable of moving up and down, and is controlled by the computer so that, when current is applied to the semiconductor laser chip, it moves upward, moves through the adhesive sheet, and contacts the back-surface electrode. The first current applying probe and the second current applying probe are connected to the power supply.

The power supply applies current to the upper-surface electrode and the back-surface electrode from the first and second current applying probe to cause outgoing light to be emitted from the light-emitting end surfaces of the semiconductor laser chip. The light detector detects the outgoing light. Examples of the light detector are a light power meter and a light spectrum analyzer.

The optical characteristic inspecting means determines the goodness or badness of the optical characteristics of the semiconductor laser chip. In this application, the optical characteristics inspecting means is added to the computer, and a publicly known technology is used to determine the goodness or badness of the optical characteristics.

The procedure of inspecting the optical characteristics of a semiconductor laser chip using the visual inspection apparatus according to the Application 3 will be described.

The steps until the semiconductor laser chip that is an inspection object is positioned above the other semiconductor laser chips by pushing the semiconductor laser chip that is an inspection object upward from the back surface of the adhesive sheet by the push-up member are the same as those described with reference to FIG. 3. In this state, the first current applying probe is moved downward and is made to contact the upper-surface electrode of the semiconductor laser chip that is an inspection object. In addition, the second current applying probe, built in the push-up member, is moved upward, moves through the adhesive sheet, and is made to contact the back-surface electrode of the semiconductor laser chip that is an inspection object. Next, by applying current to the upper-surface electrode and the back-surface electrode by applying electrical signals to the first and second current applying probes from the power supply, the outgoing light is emitted from the light-emitting end surfaces of the semiconductor laser chip and the outgoing light is detected by the light detector. At this time, the CCD cameras for taking the images of the end surfaces of the semiconductor chip are replaced to the light detector. Then, on the basis of the results of the optical characteristics detected at the light detector, the optical characteristic inspecting means determines the goodness or badness of the optical characteristics of the semiconductor laser chip. If the cameras are CCD cameras, the cameras are sensitive to a light-emission wavelength of the outgoing light, and have good output linearity with respect to the outgoing light. Therefore, the CCD cameras are capable of providing an end-surface imaging function and a light detector function.

In this way, in the visual inspection apparatus of the Application 3, it is possible not only to inspect the appearance of the light-emitting end surfaces of the semiconductor laser chip, but also to inspect the optical characteristics of the semiconductor laser chip. Since the semiconductor laser chip that is an inspection object is positioned above the other semiconductor laser chips, it is possible to detect the outgoing light of the semiconductor laser chip that is an inspection object with the light detector without being interfered by the other semiconductor laser chips.

The present invention is not limited to the above-described embodiment, so that various modifications may be made as appropriate without departing from the gist of the present invention. For example, it is possible to select a semiconductor laser bar that is an inspection object and to set the size of the shape of the upper surface of the push-member in correspondence with the semiconductor laser bar. In this case, it is possible to inspect the light-emitting end surfaces in semiconductor laser bar units.

What is claimed is:

1. An visual inspection apparatus for a semiconductor laser chip or a semiconductor laser bar, the visual inspection apparatus comprising:
a stage at which an adhesive sheet is placed, a plurality of the semiconductor laser chips or a plurality of the semiconductor laser bars being adhered to a surface of the adhesive sheet;
a push-up member that pushes up a semiconductor laser chip or a semiconductor laser bar that is an inspection object among the plurality of the semiconductor laser chips or the plurality of the semiconductor laser bars from the back surface of the adhesive sheet to position the semiconductor laser chip or the semiconductor laser bar that is an inspection object above the other semiconductor laser chips or the other semiconductor laser bars;
a camera that takes an image of a light-emitting end surface of the semiconductor laser chip or the semiconductor laser bar pushed up by the push-up member; and
visual inspecting means for determining the goodness or badness of the image of the appearance of the semiconductor laser chip or the semiconductor laser bar taken by the camera on the basis of information of the image of the light-emitting end surface of the semiconductor laser chip or the semiconductor laser bar taken by the camera.

2. The visual inspection apparatus for a semiconductor laser chip or a semiconductor laser bar according to claim 1, further comprising:
upward-downward position adjusting means for adjusting an upward or a downward position of the semiconductor laser chip or the semiconductor laser bar whose image is taken with the camera by moving the stage and the push-up member relative to each other in an upward-downward direction in accordance with a imaging range of the camera.

3. The visual inspection apparatus for a semiconductor laser chip or a semiconductor laser bar according to claim 1, further comprising:
two of the cameras,
wherein the images of both of the light-emitting end surfaces of the semiconductor laser chip or the semiconductor laser bar that is an inspection object are taken by the different cameras, respectively.

4. The visual inspection apparatus for a semiconductor laser chip or a semiconductor laser bar according to claim 1, wherein the size of the shape of the upper surface of the push-up member is set in correspondence with the semiconductor laser chips or the semiconductor laser bars.

5. The visual inspection apparatus for a semiconductor laser chip or a semiconductor laser bar according to claim 1, wherein the upper surface of the push-up member has a suction hole communicating with a vacuum pump.

6. The visual inspection apparatus for a semiconductor laser chip or a semiconductor laser bar according to claim 1, the visual inspection apparatus further comprising:
a first current applying probe that is disposed above the stage and that contacts a upper-surface electrode of the semiconductor laser chip that is an inspection object;
a second current applying probe that is mounted to the push-up member, the second current applying probe moving through the adhesive sheet to contact a back-surface electrode of the semiconductor laser chip;
a power supply that causes outgoing light to be emitted from the light-emitting end surface of the semiconductor laser chip by applying current to the upper-surface electrode and the back-surface electrode from the first and second current applying probes;
a light detector that detects the outgoing light; and
optical characteristic inspecting means for determining the goodness or badness of optical characteristics of the semiconductor laser chip on the basis of detection results of the light detector.

7. The visual inspection apparatus for a semiconductor laser chip or a semiconductor laser bar according to claim 1, further comprising:
position information detecting means for detecting information of a horizontal-direction position of the semiconductor laser chip or the semiconductor laser bar that is an inspection object; and
horizontal position adjusting means for, on the basis of the position information obtained from the position information detecting means, moving the stage horizontally so that the semiconductor laser chip or the semiconductor laser bar comes directly above the push-up member.

8. A method of inspecting an appearance of a semiconductor laser chip or a semiconductor laser bar, the method comprising the steps of:
placing an adhesive sheet at a stage, a plurality of the semiconductor laser chips or a plurality of the semiconductor laser bars being adhered to a surface of the adhesive sheet;
pushing up a semiconductor laser chip or a semiconductor laser bar that is an inspection object among the plurality of the semiconductor laser chips or the plurality of the semiconductor laser bars by a push-up member from the back surface of the adhesive sheet to position the semiconductor laser chip or the semiconductor laser bar that is an inspection object above the other semiconductor laser chips or the other semiconductor laser bars;
taking an image of a light-emitting end surface of the semiconductor laser chip or the semiconductor laser bar pushed up by the push-up member with a camera; and
determining the goodness or badness of the appearance of the semiconductor laser chip or the semiconductor laser bar on the basis of information of the image of the light-emitting end surface of the semiconductor laser chip or the semiconductor laser bar taken by the camera in the imaging step.

9. The method according to claim 8, wherein, in the imaging step, the image of the entire light-emitting end surface is taken in a plurality of steps while, in accordance with a imaging range of the camera, the stage and the push-up member are moved upward or downward and an upward position or a downward position of the semiconductor laser chip or the semiconductor laser bar whose image is taken by the camera is adjusted.
